(19) United States
(12) Patent Application Publication
(10) Pub. No.: US 2002/0071216 A1
(43) Pub. Date: Jun. 13, 2002

(54) Disc drive having an air bearing surface with trenched contact protection feature

(76) Inventors: Anthony P. Sannino, Longmont, CO (US); Zine Eddine Boutaghou, Vadnais Heights, MN (US); James R. Krolnik, Brooklyn Park, MN (US)

Correspondence Address: SCHWEGMAN, LUNDBERG, WOESSNER & KLUTH, P.A., P.O. BOX 2938, MINNEAPOLIS, MN, 55402, US

(21) Appl. No.: 09/885,484

(22) Filed: Jun. 20, 2001

Related U.S. Application Data
(60) Provisional application No. 60/212,932, filed on Jun. 20, 2000.

(51) Int. Cl. G11B 5/60

(52) U.S. Cl. 360/236.1; 360/237

(57) ABSTRACT

An information handling system, such as a disc drive includes a base, a disc rotatably attached to the base, and an actuator attached to the base. The disc drive also includes a slider attached to the actuator. The slider has an air-bearing surface which includes a first rail, a second rail, a cavity positioned between the first rail and the second rail, and at least one contact protection feature positioned near at least one corner of the air bearing surface. The contact protection feature may be located at or near the trailing edge. In other embodiments, the contact protection feature may be located at or near the leading edge of the slider. The contact protection feature includes a trench bordered by three side with an open end facing the leading edge of the slider.

### RELATED APPLICATION

This application claims the benefit of U.S. Provisional Application Ser. No. 60/212,932, filed Jun. 20, 2000 under 35 U.S.C. 119(e).

### FIELD OF THE INVENTION

The present invention relates to the field of mass storage devices. More particularly, this invention relates to a disc drive which includes a slider having a corner contact protection feature or features associated with the air-bearing surface of the slider.

### BACKGROUND OF THE INVENTION

One of the key components of any computer system is a place to store data. One common place for storing data in a computer system is on a disc drive. The most basic parts of a disc drive are a disc that is rotated, an actuator that moves a transducer to various locations over the disc, and electrical circuitry that is used to write and read data to and from the disc. The disc drive also includes circuitry for encoding data so that it can be successfully retrieved and written to the disc surface. A microprocessor controls most of the operations of the disc drive as well as passing the data back to the requesting computer and taking data from a requesting computer for storing to the disc. The magnetic transducer translates electrical signals into magnetic field signals that actually record the data “bits.”

The discs are typically rigid discs, which are coated with a magnetizable medium for storage of digital information in a plurality of circular, concentric data tracks. The discs are mounted on a spindle motor, which causes the discs to spin and the surfaces of the discs to pass under respective hydrodynamic (e.g. air) bearing disc head sliders. The sliders carry at least one transducer.

The transducer is typically housed within a small ceramic block called a slider. The slider is passed over the rotating disc in close proximity to the disc. The transducer can be used to read information representing data from the disc or write information representing data to the disc. When the disc is operating, the disc is usually spinning at relatively high revolutions per minute (“RPM”). A current common rotational speed is 7200 RPM. Rotational speeds in high-performance disc drives are as high as 15,000 RPM. Higher rotational speeds are contemplated for the future.

The slider is usually aerodynamically designed so that it flies on the cushion of air that is dragged by the disc. The slider has an air-bearing surface (“ABS”) which includes rails and a cavity or depression between the rails. The air-bearing surface is that surface of the slider nearest the disc as the disc drive is operating. Air is dragged between the rails and the disc surface causing an increase in pressure which tends to force the head away from the disc. Simultaneously, air rushing past the cavity or depression in the air-bearing surface produces a lower than ambient pressure area at the cavity or depression. This vacuum effect counteracts the pressure produced at the rails. The opposing forces equilibrate so the slider flies over the surface of the disc at a particular fly height. The fly height is the thickness of the air lubrication film or the distance between the disc surface and the transducing head. This film minimizes the friction and resulting wear that would occur if the transducing head and disc were in mechanical contact during disc rotation.

Information representative of data is stored on the surface of the memory disc. Disc drive systems read and write information stored on tracks on memory discs. Transducers, in the form of read/write heads attached to the sliders, located on both sides of the memory disc, read and write information on the memory discs when the transducers are accurately positioned over one of the designated tracks on the surface of the memory disc. The transducer is also said to be moved to a target track. As the memory disc spins and the read/write head is accurately positioned above a target track, the read/write head can store data onto a track by writing information representative of data onto the memory disc. Similarly, reading data on a memory disc is accomplished by positioning the read/write head above a target track and reading the stored material on the memory disc. To write on or read from different tracks, the read/write head is moved radially across the tracks to a selected target track. The data is divided or grouped together on the tracks. In some disc drives, the tracks are a multiplicity of concentric circular tracks. In other disc drives, a continuous spiral is one track on one side of a disc drive. Servo feedback information is used to accurately locate the transducer. The actuator assembly is moved to the required position and held accurately during a read or write operation using the servo information.

The best performance of the disc drive results when the slider is flown as closely to the surface of the disc as possible. In operation, the distance between the slider and the disc is very small; currently “fly” heights or head media spacing is about 0.5 micro inches. It is contemplated that smaller fly heights or head media spacing will be achieved in the future since this is one factor in achieving increased recording density.

In ramp load-unload applications, the disc drive further includes a ramp positioned at an outer diameter of the disc for engaging the suspension. When the disc drive is powered down, the actuator mechanism moves the head gimbal assembly radially outward until the suspension engages the ramp, causing the slider to lift off of the disc surface. During power-up, the disc is accelerated to its normal operating velocity and then the actuator mechanism moves the head gimbal assembly radially inward such that the suspension disengages the ramp allowing the slider to become loaded on to the disc surface.

Using a ramp to load and unload the head gimbal assembly to and from the disc surface has been regarded as an attractive alternative to “contact start/stop” technology in which the slider lands and takes-off from a dedicated zone on the disc surface. The ramp load-unload technique can be used for solving tribological problems associated with lower fly heights and for meeting severe requirements of non-operational shock performance. However, this technique introduces an array of other challenges, such as possible severe head-media impact during loading and unloading operation.

Under nominal conditions, advanced air bearings (AABs) can be designed to avoid head-media contact during load and unload. Manufacturing of actual parts, however, introduces deviation from nominal conditions, which can result in larger susceptibility of impact during load-unload operations. Among the numerous dimensions and geometrical features to be controlled during manufacturing, pitch static angle (PSA) and roll static angle (RSA) are the most critical parameters for load-unload applications. PSA is the angle formed between the slider and the suspension in a direction parallel to the suspension's axis of symmetry when no air bearing is formed (i.e., in a “static” state). RSA is the angle formed between the slider and the suspension in a direction perpendicular to the suspension's axis of symmetry. Since PSA and RSA have an influence on the pitch and roll attitude of the slider during flight, a non-optimal PSA or RSA results in the slider tilting with respect to the radial motion of the suspension during loading and unloading operations. Under these conditions, it is possible that the corners of the slider can contact the disc. If the contact is severe the result can be damage to stored data and permanent physical damage to the media. This is also known as a head crash. The result may be permanent loss of the data, which is very undesirable in a device designed to reliably store data.

Of course, as fly heights get lower or smaller the problems associated with the slider pivoting about the roll axis become more pronounced. Essentially, at lower fly heights there is less margin for error when the slider rolls. In other words, at low fly heights even a slight roll may cause contact between the slider and the disc.

What is needed is a slider air-bearing design which will minimize or prevent the possibility of contact between the slider and the disc. What is also needed is a design for controlling the amount of roll during loading and unloading the disc. In addition, there is a need for a slider air-bearing design that adds robustness by preventing or reducing slider disc contact over an acceptable range of manufacturing deviations from nominal roll static attitude. This will build in more leeway before contact between the slider and the disc. The result is more consistent read and write performance characteristics amongst the heads in a disc drive.

### SUMMARY OF THE INVENTION

An information handling system, such as a disc drive includes a base, a disc rotatably attached to the base, and an actuator attached to the base. The disc drive also includes a slider attached to the actuator. The slider has an air-bearing surface which includes a first rail, a second rail, a cavity positioned between the first rail and the second rail, and at least one contact protection feature positioned near at least one corner of the air bearing surface. The slider is further includes a first edge near the first rail, and a second edge near the second rail. The slider also includes a leading edge, and a trailing edge. The at least one contact feature is located near the trailing edge of the slider and near one of the first rail and the second rail of the slider, and located near the first edge or the second edge corresponding to the first rail or the second rail of the slider. In some embodiments, the contact protection feature includes a trench bordered by three side walls. The three walls form a u-shaped border with an open end. The open end of the u-shaped border is near the leading edge of the slider. In some embodiments, there is a second contact protection feature. The first contact protection feature and the second contact protection feature are located near the trailing edge of the slider.

A slider for a disc drive includes an air-bearing surface. The air-bearing surface includes a first rail, a second rail, and a cavity positioned between the first rail and the second rail. The air-bearing surface also includes at least one contact protection feature positioned near at least one corner of the air-bearing surface. The slider also includes a leading edge, and a trailing edge. In one embodiment, the at least one contact protection feature is located near the trailing edge of the slider. More specifically, the at least one contact protection feature located near the trailing edge of the slider, and near one of the first rail and the second rail of the slider. The slider also has a first edge near the first rail, and a second edge near the second rail. The at least one contact feature is also located near the first edge or the second edge corresponding to the first rail or the second rail of the slider. In some embodiments, there is a gap between the at least one contact protection feature and the nearer of the first rail and the second rail of the slider. In other embodiments, the space between the contact protection feature and the nearer of the first rail and the second rail of the slider is substantially continuous. In some other embodiments, the contact protection feature includes a trench. The trench is bordered by three side walls which form a u-shaped border with an open end. The open end of the u-shaped border is near the leading edge of the slider.

In some embodiments, the air-bearing surface includes a second contact protection feature. The first contact protection feature and the second contact protection feature are located near the trailing edge of the slider in some embodiments. In other embodiments, the first contact protection feature and the second contact protection feature are located near the leading edge of the slider. In these embodiments, the contact protection feature also includes a trench bordered by three side walls which form a u-shaped border with an open end. The open end of the u-shaped border is near the leading edge of the slider.

In other embodiments, the slider includes four contact protection features. The first contact protection feature and the second contact protection feature are located near the trailing edge of the slider while the third contact protection feature and the fourth contact protection feature are located near the leading edge of the slider.

Advantageously, slider having an air-bearing surface with contact protection features minimizes or prevents the possibility of contact between the slider and the disc. The use of contact protection features controls the amount of roll during loading and unloading of the disc. This in turn adds robustness to the disc drive as well as to the slider since the disc contact features prevent or reduce the possibility of slider to disc contact over the life of the drive. Using the contact features also adds to the robustness of the design since it accommodates a range of manufacturing deviation form nominal roll static attitude. This provides more leeway or margin before contact occurs. The result is a more consistent read and write performance characteristic among manufactured head in the disc drive.

### BRIEF DESCRIPTION OF THE DRAWINGS

FIG. 1 is an exploded view of a disc drive with a multiple disc stack.

FIG. 2 is a side view of a disk drive having a ramp structure.

FIG. 3 is a end view of a slider on the tip of the ramp structure.

FIG. 4 is a bottom view of the slider showing the air bearing surface of a slider without contact protection features.

FIG. 5 is a bottom view of the slider showing the air bearing surface with a first embodiment of a slider with contact protection features.

FIG. 6 is a bottom view of a slider showing the air bearing surface with a second embodiment of a slider with contact protection features.

FIG. 7 a bottom view of the slider showing the air bearing surface with a third embodiment of a slider with contact protection features.

FIG. 8 is a trench diamond like carbon (“DLC”) pad.

FIG. 9 a bottom view of a slider showing the air bearing surface with a fourth embodiment of a slider with contact protection features.

FIG. 10 is a bottom view of a slider showing the air bearing surface with a fifth embodiment of a slider with contact protection features.

FIG. 11 is a pressure profile for an air-bearing surface having a center pad and an extended side step contact protection feature.

FIG. 12 is a pressure profile for an air-bearing surface having a center pad and an extended side step contact protection feature with a first and second trench.

FIG. 13 is a schematic view of a computer system.

### DESCRIPTION OF THE PREFERRED EMBODIMENT

In the following detailed description of the preferred embodiments, reference is made to the accompanying drawings which form a part hereof, and in which are shown by way of illustration specific embodiments in which the invention may be practiced. It is to be understood that other embodiments may be utilized and structural changes may be made without departing from the scope of the present invention.

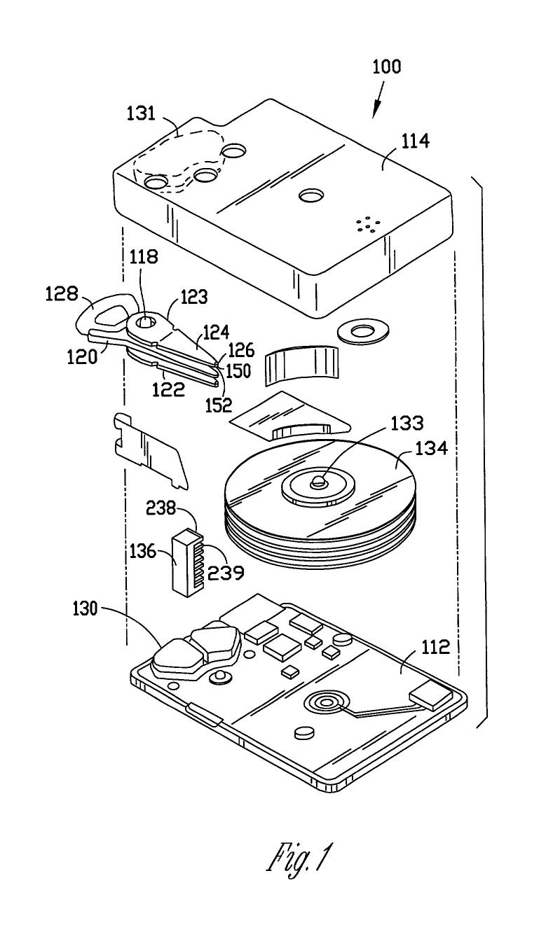

The invention described in this application is useful with all mechanical configurations of disc drives having either rotary or linear actuation. In addition, the invention is also useful in all types of disc drives including hard disc drives, zip drives, floppy disc drives and any other type of drives where unloading the transducer from a surface and parking the transducer may be desirable. FIG. 1 is an exploded view of one type of a disc drive 100 having a rotary actuator. The disc drive 100 includes a housing or base 112, and a cover 114. The base 112 and cover 114 form a disc enclosure. Rotatably attached to the base 112 on an actuator shaft 118 is an actuator assembly 120. The actuator assembly 120 includes a comb-like structure 122 having a plurality of arms 123. Attached to the separate arms 123 on the comb 122, are load beams or load springs 124. Load beams or load springs are also referred to as suspensions. Attached at the end of each load spring 124 is a slider 126 which carries a magnetic transducer 150. The slider 126 with the transducer 150 form what is many times called the head. It should be noted that many sliders have one transducer 150 and that is what is shown in the figures. It should also be noted that this invention is equally applicable to sliders having more than one transducer. Also attached to the load spring is a load tang 152. The load tang 152 is used for loading sliders 126 to the disc 134 and unloading the sliders 126 from the disc. On the end of the actuator arm assembly 120 opposite the load springs 124 and the sliders 126 is a voice coil 128.

Attached within the base 112 is a pair of magnets 130 and 131. The pair of magnets 130 and 131, and the voice coil 128 are the key components of a voice coil motor which applies a force to the actuator assembly 120 to rotate it about the actuator shaft 118. Also mounted to the base 112 is a spindle motor. The spindle motor includes a rotating portion called the spindle hub 133. In this particular disc drive, the spindle motor is within the hub. In FIG. 1, a number of discs 134 are attached to the spindle hub 133. In other disc drives a single disc or a different number of discs may be attached to the hub. The invention described herein is equally applicable to such other disc drives.

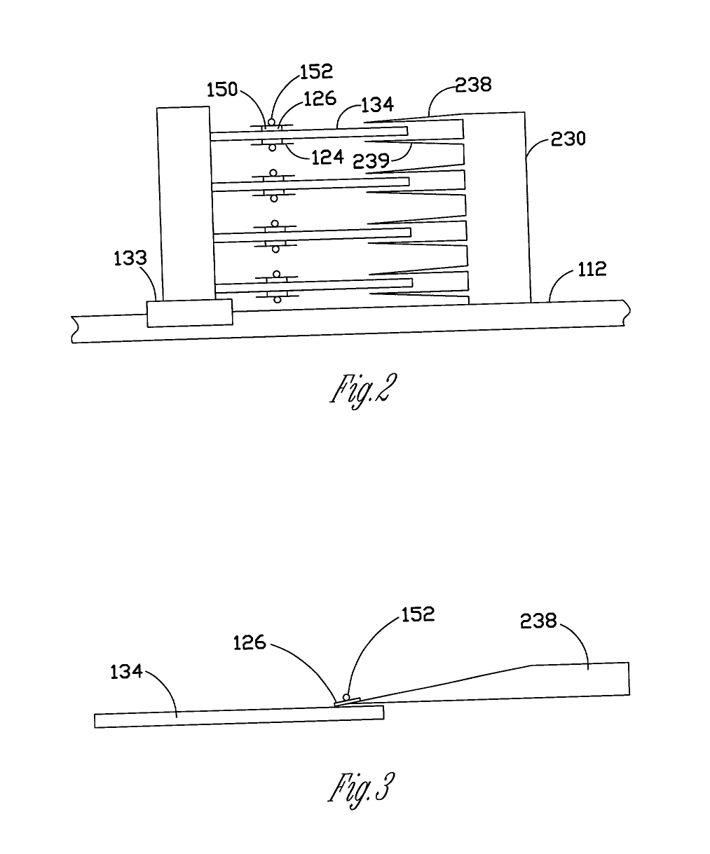

Also attached to the base 112 is a ramp structure 136. FIG. 2 is a side view of a disk drive having a ramp structure. Now looking at FIG. 2, the ramp structure will be described in more detail. The ramp structure 136 has a plurality of individual ramps 238 and 239. One ramp is associated with each surface of the disk. As shown, there is a ramp portion 238 for the top surface of a disk and a ramp 239 for a bottom surface of the disk 134. The ramp portion 238 is for the loading and unloading the transducer from the top surface of a disk 134 and the ramp portion 239 is for loading and unloading a transducer from the bottom surface of a disk 134. The disk drive shown in FIG. 2 has four disks. Each disk 134 has two surfaces so there are a total of eight disk surfaces within the disk drive shown. Only one disk and set of ramps 238 and 239 are labeled. The other disks and ramps are similar to the labeled disk 134 and set of ramps 238 and 239. The ramp structure 136 shown in FIG. 2 is fixed to the base of the disk drive. The ramp structure can be formed as one unitary part or can be assembled from a number of different parts. For example, the ramp structure 134 shown could be comprised of four parts. Each part would include a set of ramps 238 and 239 and a main body 230 to which the ramps 238 and 239 are attached. a portion of each of the ramp portions 238 and 239 of the ramp is positioned over the disk 134. It should be noted that this invention could also be used on ramps that rotate in and out of a load/unload position.

Also shown in FIG. 2 are the load springs 124, which are referred to by some as load beams or suspensions, and the attached load tangs 152. The load tangs 152 are attached to the load springs 124. The slider 124 and transducer 150 carried by the slider are not illustrated in FIG. 2 for the sake of clarity. All the load springs 124 and tangs 152 are attached to the actuator. Moving the actuator assembly 120 moves all the load springs 124 and load tangs 152.

Moving the actuator assembly 120 moves all the load springs 124 in unison. In operation, the actuator assembly 120 is moved to a park position when the disc drive is powered down. Moving the actuator to the park position causes the load tangs 152 associated with each load spring 124 to ride up the ramp 238 or 238′ associated with the surface of the disk 134. This is referred to as unloading the disk. In a disc drive having a ramp, the actuator moves the transducers to the outer diameter where a ramp is positioned. a portion of the actuator assembly, namely the load tangs 152, contacts the ramp resulting in the sliders 126 being unloaded from the disc 134. Once the actuator assembly 120 has moved the sliders 126 to the park position, the drive is powered down.

When the disc drive is powered on, the discs 134 are quickly accelerated to a speed where the relative velocity between the sliders 126 and the disc 134 would cause the slider to lift off the surface of the disc 134. When operations resume, the actuator is moved toward the disc. The sliders and transducers are placed in transducer relation to the disc or is loaded onto the disc. The actuator assembly 120 can be used to move the sliders 126 into an operating or transducing position over the area of the disc used to store information representative of data. This is referred to as loading the disk. The load springs 124, load tangs 152 sliders 124 and transducers 150 of the disk drive are shown in a transducing position in FIG. 2. It should be noted that much of the actuator assembly 120 has been eliminated from FIG. 2 for the sake of clarity. The actuator assembly 120 can also be used to perform seeks to various data locations on the surface of the disc.

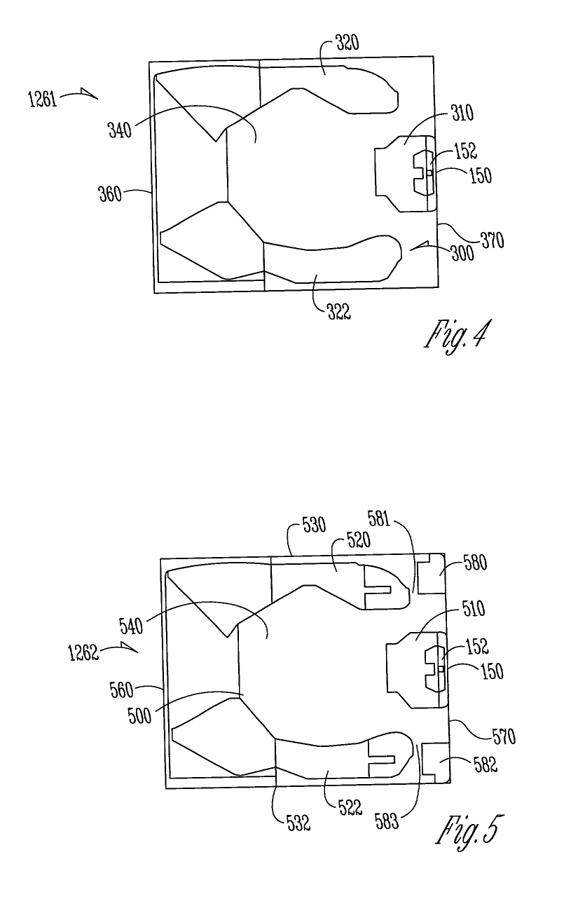

FIG. 3 is an end view of the slider 126 at the tip of the ramp structure 238. This is the position of the slider 126 either during loading of the slider 126 from the ramp 238 onto the disk or during unloading of the slider from the disk 134. During unloading, the slider 126 is removed from the surface of the disk 134 and parked on the ramp 238. As can be seen, the slider tilts or rolls either during loading or unloading of the slider when a ramp is used.

FIG. 4 is a bottom view of a slider 126 showing an air-bearing surface 300. The air-bearing surface includes a single center pad 310, a first side rail 320 and a second side rail 322. The air-bearing surface 300 includes contact portions which contact the disc 134 during take-off and landing of the slider 126 and non-contact portions which do not normally contact the disc 134. The center pad 310 and side rails 320 and 322 are contact portions. a single-level cavity 340 is typically formed between the side rails 320 and 322 as well as the center pad 310. The single-level cavity 340 is a non-contact portion of the air-bearing surface 300. The slider also has a leading edge 360 and a trailing edge 370. Positioned at or near the trailing edge 370 is the transducer 150. As shown in FIG. 4, the transducer fits within a slot 152 within the single center pad 310.

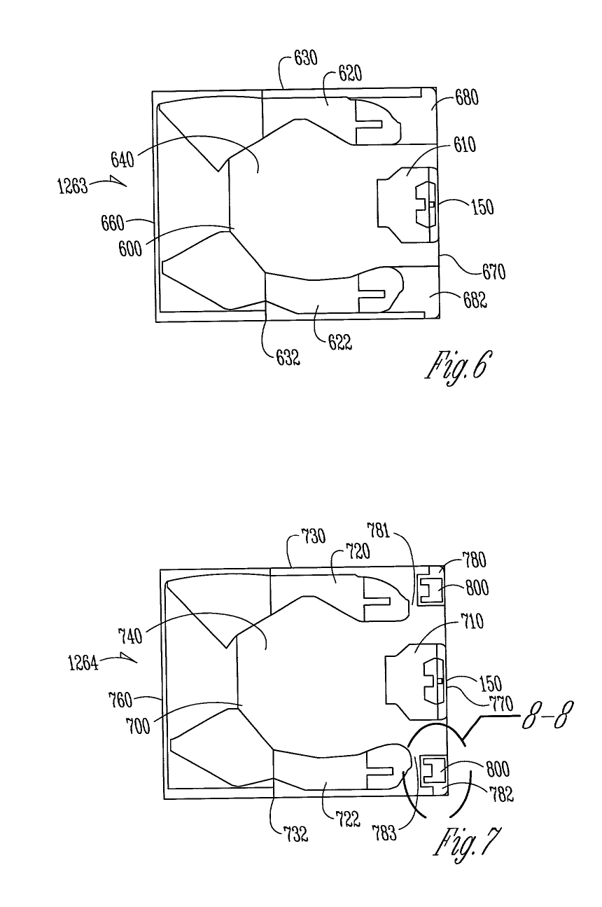

FIG. 5 is a bottom view of a slider 1262 showing the air-bearing surface 500 with a first embodiment of a slider with contact protection features 580 and 582. The slider includes an edge 530 which is positioned near the first rail 520, and an edge 532 positioned near the rail 522. a first contact feature 580 is positioned near the trailing edge 570 and toward the edge 530 of the slider 1262. The second contact protection feature 582 is positioned near the trailing edge 570 and near the edge 532 of the slider 1262. The contact protection features 580, 582 are separate from the side rails 520 and 522. In other words, the side rail 520 terminates before the contact protection feature 580. In fact there is a gap 581 between the side rail 520 and the contact protection feature 580. Similarly there is a gap 583 between the second side rail 522 and the second contact protection feature 582. In operation when the slider flies with a slight attitude where the leading edge 560 is higher than the trailing edge 570 the contact protection features 580 and 582 located at the corners produce a high pressure area at the corners of the slider. The corners protected are the corners at the trailing edge and also near the edges 530 and 532 of the slider 1262. The high pressure point at the corners prevents the corners from contacting a disc 134 (shown in FIG. 1) when flying or passing over in transducing relationship with respect to the disc 134. The high pressure at the corner prevents the slider from contacting the disc, and since when a roll motion is being induced in the slider 1262, the layer of air between, for example, contact protection feature 580 and the disc 134 becomes extremely compressed or almost incompressible when there is only a slight distance between the contact protection feature 580 and the disc. This is very significant in that the high pressure prevents the roll of the slider 1262. The reason it is significant is that when a slider is loaded or unloaded from the disc the corners of the slider where the contact protection features 580 and 582 are located are the most likely to contact the slider. Given that the slider typically has a slight attitude from the leading edge 560 to the trailing edge 570 the protection features 580 and 582 prevent or minimize contact between the slider 1262 corner and the disc 134. Turning briefly back to FIG. 3 it can be seen that a slider 126 tends to roll when the slider is being loaded or unloaded from the ramp 238 onto the surface of the disc 134. Thus the contact protection features 580 and 582 located at the corners of the slider 1262 prevent or minimize the occurrence of contact with the corners near the trailing edge 570 of the slider 1262 from contacting the disc during loading and unloading of the slider 1262 from the surface of the disc 134.

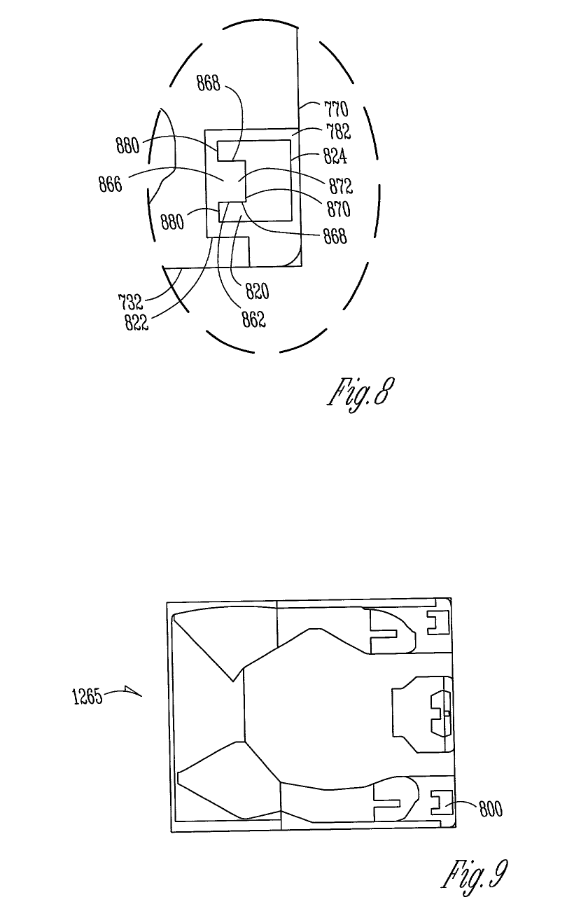

FIG. 6 is a bottom view of a slider 1263 showing the air-bearing surface 600 with a second embodiment of a slider 1263 with contact protection features 680, 682. The slider 1263 includes a leading edge 660 and a trailing edge 670. The slider also includes a first side rail 620 and second side rail 622 on the air-bearing surface 600. Between the side rails 620 and 622 is a cavity 640 which produces negative pressure along the air-bearing surface 600. Also included on the air-bearing surface at the trailing edge is a center pad 610 which includes the transducer 150. a pair of contact protection features 680 and 682 are located at the trailing edge 670 of the slider 1263. The contact protection features are also located along edge 630 and 632 of the air-bearing surface 600 of the slider 1263. The edge 630 is near the first side rail 620 and the edge 632 is near the second side rail 622. Therefore the contact protection features 680 and 682 are located at the rearward or trailing edge corners of the air-bearing surface 600. The embodiment shown in FIG. 6 differs from the embodiment shown in FIG. 5 in that the contact protection features 680 and 682 are incorporated into the side rails 620 and 622, respectively. In other words, the side rails 620 and 622 are elongated or extended to incorporate the contact protection feature 680 and 682.

In operation the contact protection features 680 and 682 work fundamentally the same as the contact protection features 580 and 582. Rather than repeat the details of how the contact protection features 680 and 682 work in operation, the reader is referred back to the paragraph detailing the operation of the air-bearing surface with the contact protection features 580 and 582.

FIG. 7 is a bottom view of a slider 1264 showing the air-bearing surface 700 with a first embodiment of a slider with contact protection features 780 and 782. The slider includes an edge 730, which is positioned near the first rail 720, and an edge 732 positioned near the rail 722. a first contact feature 780 is positioned near the trailing edge 770 and toward the edge 730 of the slider 1264. The second contact protection feature 782 is positioned near the trailing edge 770 and near the edge 732 of the slider 1264. The contact protection features 780, 782 are separate from the side rails 720 and 722. In other words, the side rail 720 terminates before the contact protection feature 780. In fact there is a gap 781 between the side rail 720 and the contact protection feature 780. Similarly there is a gap 783 between the second side rail 722 and the second contact protection feature 782. In operation when the slider flies with a slight attitude where the leading edge 760 is higher than the trailing edge 770 the contact protection features 780 and 782 located at the corners produce a high pressure area at the corners of the slider. The corners protected are the corners at the trailing edge and also near the edges 730 and 732 of the slider 1264. The high pressure point at the corners prevents the corners from contacting a disc 134 (shown in FIG. 1) when flying or passing over in transducing relationship with respect to the disc 134. The high pressure at the corner prevents the slider from contacting the disc, and since when a roll motion is being induced in the slider 1264, the layer of air between, for example, contact protection feature 780 and the disc 134 becomes extremely compressed or almost incompressible when there is only a slight distance between the contact protection feature 780 and the disc. This is very significant in that the high pressure prevents the roll of the slider 1264. The reason it is significant is that when a slider is loaded or unloaded from the disc, the corners of the slider where the contact protection features 780 and 782 are located are the most likely to contact the slider. Given that the slider typically has a slight attitude from the leading edge 760 to the trailing edge 770 the protection features 780 and 782 prevent or minimize contact between the slider 1264 corner and the disc 134. Turning briefly back to FIG. 3 it can be seen that a slider 126 tends to roll when the slider is being loaded or unloaded from the ramp 238 onto the surface of the disc 134. Thus the contact protection features 780 and 782 located at the corners of the slider 1264 prevent or minimize the occurrence of contact with the corners near the trailing edge 770 of the slider 1264 from contacting the disc during loading and unloading of the slider 1264 from the surface of the disc 134.

The contact protection features 780 and 782 differ from the contact protection features 580 and 582 in that they include a trenched DLC pad 800. For the sake of simplicity only one of these trenched DLC pads 800 will be described. The channel 800 can also be referred to as a trench. The channel 800 has a leading channel end 866, non-divergent side walls 868, a trailing channel end 870 and a channel floor (or “step surface”) 872. Channel 800 also has a side wall 880 to either side of the leading channel end 866. The channel 800 is formed through photolithography processes such as ion milling, chemical etching or reactive ion etching (RIE). With these processes, the depth and location of the channels can be accurately controlled. In one embodiment, the channel floors 872 of the channel 800 is coplanar and contiguous with side rails of the slider.

The leading channel end 866 is open to fluid flow. However the trailing channel end 870 is closed to fluid flow. a portion of the fluid flow is directed into channel 800 and is forced to exit the channel 800 over the trailing channel end 870. This creates localized positive pressure areas on trailing bearing surfaces 820 rearward of trailing channel ends 870. In one embodiment, trailing bearing surfaces 820 have a length measured from trailing channel ends 870 to trailing rail edges 824 that is equal to or greater than the width of channels 860 and 862, as measured between side walls 868. This provides enough of a bearing surface on which the localized positive pressure can act. The localized positive pressure developed on trailing bearing surfaces 820 increases the roll stiffness of the slider 1262, 1263, 1264, 1265, 1266.

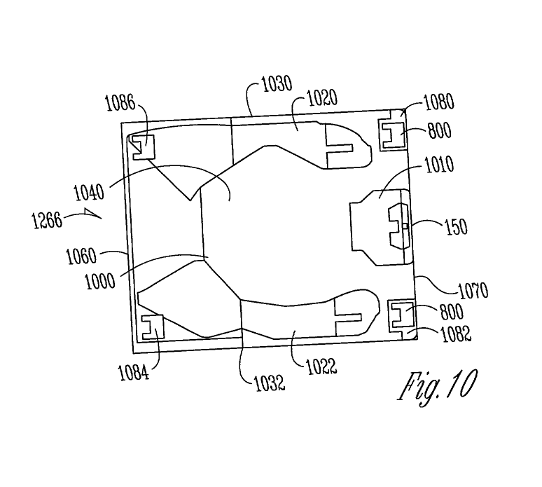

During operation, the side walls to either side of leading channel ends 866 present themselves as a substantial pressure rise to the local fluid flow. Since the opening to each channel, at leading channel ends 866, does not have the same pressure rise, it is seen as a preferential path for the fluid flow to travel. Once the fluid flow enters channel 800, the flow is essentially bounded by channel side walls 868 and trailing channel end 870 and is forced to rise over trailing channel end 870. This creates the localized pressure areas at discrete regions on the rails and specifically at the corners of the slider where the channel 800 is positioned. The channel 800 can be symmetrical about the lateral center line, as shown in FIG. 8, or can be asymmetrical to provide preferential pressurization at certain slider skew angles.

The size and intensity of the localized positive pressure areas depend on the channel length to width ratio, the absolute sizes of the channels and the depth and shape of the channel floors. In one embodiment, the ratio of the channel lengths to the channel widths range from 0.5 to 4, but may vary outside that range depending the design purposes of the channel feature. In another embodiment, the length to width ratio ranges from 0.1 to 20.

The channel or trench 800 described in FIG. 8 is situated on or is part of the contact protection feature 782 shown in FIG. 7. The contact protection feature is located toward the trailing edge 770 of the slider 1264 and also near the edge 732 of the slider 1264. It will be appreciated that the contact protection feature 780 and 782 use the same trench or channel 800 and therefore the description will not be repeated here for the sake of simplicity.

FIG. 9 is a bottom view of a slider 1265 showing an air-bearing surface 900 with a fourth embodiment of a slider 1265 having contact protection features 980 and 982. The contact protection features 980 and 982 also include channels or trenches 800, as described with respect to FIG. 8. The slider 1265 includes a leading edge 960 and a trailing edge 970. The slider also includes a first side rail 920 and second side rail 922 on the air-bearing surface 900. Between the side rails 920 and 922 is a depression 940 which produces negative pressure along the air-bearing surface 900. Also included on the air-bearing surface at the trailing edge is a center pad 910 which includes the transducer 150. a pair of contact protection features 980 and 982 are located at the trailing edge 970 of the slider 1265. The contact protection features are also located along edge 930 and 932 of the air-bearing surface 900 of the slider 1265. The edge 930 is near the first side rail 920 and the edge 932 is near the second side rail 922. Therefore the contact protection features 980 and 982 are located at the rearward or trailing edge corners of the air-bearing surface 900. The embodiment shown in FIG. 9 differs from the embodiment shown in FIG. 5 in that the contact protection features 980 and 982 are incorporated into the side rails 920 and 922, respectively. In other words, the side rails 920 and 922 are elongated or extended to incorporate the contact protection feature 980 and 982.

It should be noted that slider 1265 differs from slider 1263 in that it includes a channel 800 in each of the contact protection features 980 and 982.

FIG. 10 is a bottom view of a slider 1266. The slider 1266 has an air-bearing surface featuring a fifth embodiment of the invention which has contact protection features 1080, 1082, 1084 and 1086. The contact protection 1080, 1082, 1084 and 1086 are located at the corners of the slider. As shown in FIG. 10 each of the contact protection features 1080, 1082, 1084 and 1086 include a trench or channel 800, which produces a highly localized pressure area at the corners of the slider 1266. It is contemplated that the contact protection features 1080, 1082, 1084 and 1086 could also be fabricated without the trenches or channels 800. It is further contemplated that the contact protection features 1080, 1082, 1084 and 1086 could also be selectively provided with trenches or channels 800. In other words, the contact protection features 1080 and 1082 may be provided with channels or trenches 800 while the contact protection features 1084 and 1086 are not provided with channels or trenches 800. The slider 1266 is essentially the same as slider 1264. The notable difference is that slider 1266 includes contact protection features 1084 and 1086 located near the leading edge 1060 of the slider. The slider includes an edge 1030, which is positioned near the first rail 1020, and an edge 1032 positioned near the rail 1022. a first contact feature 1080 is positioned near the trailing edge 1070 and toward the edge 1030 of the slider 1266. The second contact protection feature 1082 is positioned near the trailing edge 1070 and near the edge 1032 of the slider 1266. The contact protection features 1080, 1082 are separate from the side rails 1020 and 1022. In other words, the side rail 1020 terminates before the contact protection feature 1080. In fact there is a gap 1081 between the side rail 1020 and the contact protection feature 1080. Similarly there is a gap 1083 between the second side rail 1022 and the second contact protection feature 1082. In operation when the slider flies with a slight attitude where the leading edge 1060 is higher than the trailing edge 1070 the contact protection features 1080 and 1082 located at the corners produce a high pressure area at the corners of the slider. The corners protected are the corners at the trailing edge and also near the edges 1030 and 1032 of the slider 1266. The high pressure point at the corners prevents the corners from contacting a disc 134 (shown in FIG. 1) when flying or passing over in transducing relationship with respect to the disc 134. The high pressure at the corner prevents the slider from contacting the disc, and since when a roll motion is being induced in the slider 1266, the layer of air between, for example, contact protection feature 1080 and the disc 134 becomes extremely compressed or almost incompressible when there is only a slight distance between the contact protection feature 1080 and the disc. This is very significant in that the high pressure prevents the roll of the slider 1266. The reason it is significant is that when a slider is loaded or unloaded from the disc, the corners of the slider where the contact protection features 1080 and 1082 are located are the most likely to contact the slider. Given that the slider typically has a slight attitude from the leading edge 1060 to the trailing edge 1070 the protection features 1080 and 1082 prevent or minimize contact between the slider 1266 corner and the disc 134. Turning briefly back to FIG. 3 it can be seen that a slider 126 tends to roll when the slider is being loaded or unloaded from the ramp 238 onto the surface of the disc 134. Thus the contact protection features 1080 and 1082 located at the corners of the slider 1266 prevent or minimize the occurrence of contact with the corners near the trailing edge 1070 of the slider 1266 from contacting the disc during loading and unloading of the slider 1266 from the surface of the disc 134.

The bearing performance of slider 110 for ramp load-unload applications can be measured against a PSA/RSA “envelope.” The PSA (Pitch Static Attitude) and RSA (Roll Static Attitude) values are important parameters for ramp load-unload applications. The PSA is the angle between the slider and the suspension arm in a direction parallel to the suspension's axis of symmetry when no air bearing is formed (i.e., static). RSA is the angle between the slider and the suspension in a direction perpendicular to the suspension's axis of symmetry. Since PSA and RSA have an influence on pitch and roll fly attitude, non-optimal PSA and/or RSA values result in a slider tilting with respect to the radial motion of the load-unload operation, which can increase the chances of contact between the head and the disc surface.

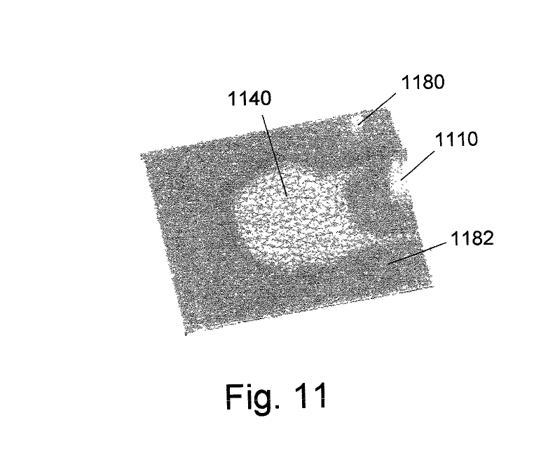

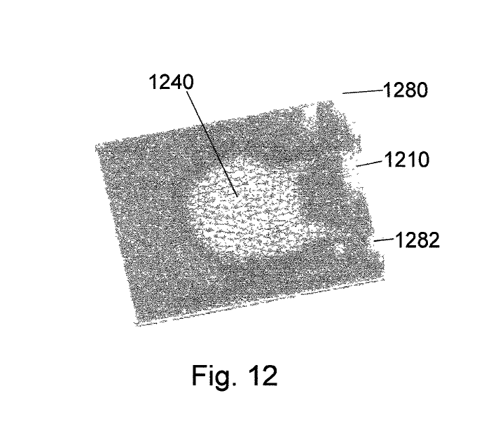

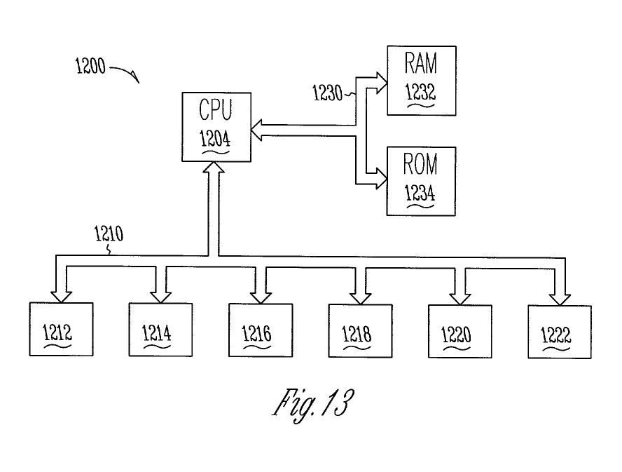

The use of contact protection features increases the load/unload robustness of the air bearing. This is achieved by widening the acceptable RSA range, or manufacturing tolerance, via increase of air bearing roll stiffness, in virtue of correlation between roll stiffness and RSA window width. Indeed, an increased roll stiffness of air bearing renders the “fly transient” and “fly steady state” roll attitude less sensitive to the roll static attitude (RSA). This consists of a conventional negative pressure design with elongated rail [2] with or without recessed areas in the middle and contact protection features in shape of a pad or extended side step (see for example FIG. 1). Such air bearing would display pressure profile plotted in FIG. 11. In addition, trenched DLC pad deposited on these contact protection features 980, 982 allow pressurization of the contact protection features 980, 982, thereby generating high localized peak pressures, FIG. 12, that significantly increase roll stiffness to larger levels than conventional negative pressure air bearing (NPAB). Table I & II both gather stiffness comparison of two sliders, 1263, 1265, without and with trench 800 on contact protection features 680, 682, 980, 982. This shows that the trenches 800 provide a superior solution on roll stiffness (0.074 versus 0.062 uN-m/urad for trenched DLC pad CPF and plain CPF, respectively). Therefore the RSA window width is improved in virtue of correlation demonstrated in [3], thereby improving load/unload performance.

TABLE I
Typical Stiffness Matrix for CPF AAB without Trenched DLC Pads on
CPF (FIG. 1B), operating conditions being identical to FIG. 2's AAB

| STIFFNESS | | PITCH | |
|---|---|---|---|
| MATRIX | HEIGHT (NM) | (uRAD) | ROLL (uRAD) |
| LOAD (G) | 0.877102E−01 | 0.456365E−01 | −0.219283E−02 |
| P-TORQUE (uN-M) | 0.296352E+00 | 0.232763E+00 | −0.408352E−02 |
| R-TORQUE | 0.152353E−01 | 0.530980E−02 | 0.615899E−01 |
| (uN-M) | | | |

TABLE II
Typical Stiffness Matrix for CPF AAB with Trenched DLC Pads on CPF
(FIG. 2B), operating conditions being identical to FIG. 1's AAB

| STIFFNESS | | PITCH | |
|---|---|---|---|
| MATRIX | HEIGHT (NM) | (uRAD) | ROLL (uRAD) |
| LOAD (G) | 0.986148E−01 | 0.478539E−01 | 0.130978E−02 |
| P-TORQUE | 0.314798E+00 | 0.239686E+00 | 0.244238E−03 |
| (uN-M) | | | |
| R-TORQUE | −0.150887E−01 | −0.859253E−02 | 0.736671E−01 |
| (uN-M) | | | |

FIG. 10 is a pressure profile of an air-bearing surface having a center pad and an extended sidestep contact protection feature. Essentially the pressure profile shown in FIG. 11 corresponds to the pressure profile produced by slider 1263 from FIG. 6. FIG. 12 is a pressure profile of an air-bearing surface having a center pad and an extended sidestep contact protection feature with a first and second trench 800. The pressure profile of FIG. 12 corresponds to the pressure profile of slider 1265 shown in FIG. 9. These pressure profiles are further evidence that the contact protection features produce high pressure areas at the corners where the contact protection features are located. As shown in FIG. 11 the extended sidestep protection features such as 680 and 682 produce high pressure areas denoted as peaks 1180 and 1182. There is also a high pressure area formed by the center pad 610 which carries the reference numeral 1110. The cavity or depression 640 produces a negative pressure area which is shown by reference numeral 1140.

FIG. 12 shows that the pressure at contact protection features 980 and 982, which each carry a trench or channel 800, are higher than the contact protection features without a trench, as compared to the pressure profile shown in FIG. 11. The cavity 940 produces a negative pressure area 1240 and the center pad 910 produces a high pressure area 1210 in the pressure profile. The high localized pressure at the contact protection features 980, 982 increases the fly transient and steady state roll stiffness of the air-bearing 900 of slider 1265. This result can be further generalized in that the trenches 800 provide for higher pressure areas at whatever corner of the slider they are placed.

Advantageously, slider having an air-bearing surface with contact protection features minimizes or prevents the possibility of contact between the slider and the disc. The use of contact protection features controls the amount of roll during loading and unloading of the disc. This in turn adds robustness to the disc drive as well as to the slider since the disc contact features prevent or reduce the possibility of slider to disc contact over the life of the drive. Using the contact features also adds to the robustness of the design since it accommodates a range of manufacturing deviation form nominal roll static attitude. This provides more leeway or margin before contact occurs. The result is a more consistent read and write performance characteristic among manufactured head in the disc drive.

FIG. 13 is a schematic view of a computer system. Advantageously, the invention is well-suited for use in a computer system 2000. The computer system 2000 may also be called an electronic system or an information handling system and includes a central processing unit, a memory and a system bus. The information handling system includes a central processing unit 2004, a random access memory 2032, and a system bus 2030 for communicatively coupling the central processing unit 2004 and the random access memory 2032. The information handling system 2002 includes a disc drive device which includes the ramp described above. The information handling system 2002 may also include an input/output bus 2010 and several peripheral devices, such as 2012, 2014, 2016, 2018, 2020, and 2022 may be attached to the input output bus 2010. Peripheral devices may include hard disc drives, magneto optical drives, floppy disc drives, monitors, keyboards and other such peripherals. Any type of disc drive may use the slider having the surface treatment discussed above.

### Conclusion

An information handling system, such as a disc drive includes a base, a disc rotatably attached to the base, and an actuator attached to the base. The disc drive also includes a slider attached to the actuator. The slider has an air-bearing surface which includes a first rail, a second rail, a cavity positioned between the first rail and the second rail, and at least one contact protection feature positioned near at least one corner of the air bearing surface. The slider is further includes a first edge near the first rail, and a second edge near the second rail. The slider also includes a leading edge, and a trailing edge. The at least one contact feature is located near the trailing edge of the slider and near one of the first rail and the second rail of the slider, and located near the first edge or the second edge corresponding to the first rail or the second rail of the slider. In some embodiments, the contact protection feature includes a trench bordered by three side walls. The three walls form a u-shaped border with an open end. The open end of the u-shaped border is near the leading edge of the slider. In some embodiments, there is a second contact protection feature. The first contact protection feature and the second contact protection feature are located near the trailing edge of the slider.

A slider for a disc drive includes an air-bearing surface. The air-bearing surface includes a first rail, a second rail, and a cavity positioned between the first rail and the second rail. The air-bearing surface also includes at least one contact protection feature positioned near at least one corner of the air-bearing surface. The slider also includes a leading edge, and a trailing edge. In one embodiment, the at least one contact protection feature is located near the trailing edge of the slider. More specifically, the at least one contact protection feature located near the trailing edge of the slider, and near one of the first rail and the second rail of the slider. The slider also has a first edge near the first rail, and a second edge near the second rail. The at least one contact feature is also located near the first edge or the second edge corresponding to the first rail or the second rail of the slider. In some embodiments, there is a gap between the at least one contact protection feature and the nearer of the first rail and the second rail of the slider. In other embodiments, the space between the contact protection feature and the nearer of the first rail and the second rail of the slider is substantially continuous. In some other embodiments, the contact protection feature includes a trench. The trench is bordered by three side walls which form a u-shaped border with an open end. The open end of the u-shaped border is near the leading edge of the slider.

In some embodiments, the air-bearing surface includes a second contact protection feature. The first contact protection feature and the second contact protection feature are located near the trailing edge of the slider in some embodiments. In other embodiments, the first contact protection feature and the second contact protection feature are located near the leading edge of the slider. In these embodiments, the contact protection feature also includes a trench bordered by three side walls which form a u-shaped border with an open end. The open end of the u-shaped border is near the leading edge of the slider.

In other embodiments, the slider includes four contact protection features. The first contact protection feature and the second contact protection feature are located near the trailing edge of the slider while the third contact protection feature and the fourth contact protection feature are located near the leading edge of the slider.

Most generally, a slider for a disc drive information handling system includes an air bearing surface, a transducer associated with the slider, and an apparatus for preventing contact with the slider associated with the air-bearing surface.

It is to be understood that the above description is intended to be illustrative, and not restrictive. Many other embodiments will be apparent to those of skill in the art upon reviewing the above description. The scope of the invention should, therefore, be determined with reference to the appended claims, along with the full scope of equivalents to which such claims are entitled.

What is claimed is:

1. A slider for a disc drive comprising:
an air-bearing surface which includes:
a first rail;
a second rail;
a cavity positioned between the first rail and the second rail; and
at least one contact protection feature positioned near at least one corner of the air bearing surface, the at least one contact protection feature including a trench.

2. The slider of claim 1 wherein the slider is further comprised of:
a leading edge; and
a trailing edge, the at least one contact protection feature located near the trailing edge of the slider.

3. The slider of claim 1 wherein the slider is further comprised of:
a leading edge; and
a trailing edge, the at least one contact protection feature located near the trailing edge of the slider and near one of the first rail and the second rail of the slider.

4. The slider of claim 1 wherein the slider is further comprised of:
a first edge near the first rail;
a second edge near the second rail;
a leading edge; and
a trailing edge, the at least one contact feature located near the trailing edge of the slider and near one of the first rail and the second rail of the slider, and located near the first edge or the second edge corresponding to the first rail or the second rail of the slider.

5. The slider of claim 4 wherein there is a gap between the at least one contact protection feature located near the trailing edge of the slider and nearer of the first rail and the second rail of the slider.

6. The slider of claim 4 wherein the space between the at least one contact protection feature located near the trailing edge of the slider, and the nearer of the first rail and the second rail of the slider is substantially continuous.

7. The slider of claim 1 wherein the trench is positioned proximate the trailing edge.

8. The slider of claim 1 wherein the trench is bordered by three side walls.

9. The slider of claim 1 wherein the trench is bordered by three side walls, the three walls forming a u-shaped border with an open end.

10. The slider of claim 7 wherein the open end of the u-shaped border is near the leading edge of the slider.

11. The slider of claim 1 further including at least a second contact protection feature, wherein the first contact protection feature and the second contact protection feature are located near the trailing edge of the slider.

12. The slider of claim 1 further including at least a second contact protection feature, wherein the first contact protection feature and the second contact protection feature are located near the leading edge of the slider.

13. The slider of claim 10 wherein the contact protection feature includes a trench bordered by three side walls, the three walls forming a u-shaped border with an open end, wherein the open end of the u-shaped border is near the leading edge of the slider.

14. The slider of claim 1 further including at least a second contact protection feature, a third contact protection feature, and a fourth contact protection feature, wherein the first contact protection feature and the second contact protection feature are located near the trailing edge of the slider and the third contact protection feature and the fourth contact protection feature are located near the leading edge of the slider.

15. A disc drive comprising:
a base;
a disc rotatably attached to the base;
an actuator attached to the base, the base also including:
a slider having:
an air-bearing surface which includes:
a first rail;
a second rail;
a cavity positioned between the first rail and the second rail; and
at least one contact protection feature positioned near at least one corner of the air bearing surface, the contact protection feature including a trench.

16. The disc drive of claim 15 wherein the slider is further comprised of:
a first edge near the first rail;
a second edge near the second rail;
a leading edge; and
a trailing edge, wherein the at least one contact feature is located near the trailing edge of the slider and near one of the first rail and the second rail of the slider, and located near the first edge or the second edge corresponding to the first rail or the second rail of the slider.

17. The disc drive of claim 16 wherein the trench is bordered by three side walls, the three walls forming a u-shaped border with an open end.

18. The slider of claim 17 wherein the open end of the u-shaped border is near the leading edge of the slider.

19. The disc drive of claim 15 further including at least a second contact protection feature, wherein the first contact protection feature and the second contact protection feature are located near the trailing edge of the slider.

20. A slider for a disc drive information handling system comprising:
an air bearing surface;
a transducer associated with the slider; and
means for preventing contact with the slider associated with the air-bearing surface.
